(19) United States
(12) Patent Application Publication
(10) Pub. No.: US 2016/0260191 A1
(43) Pub. Date: Sep. 8, 2016

(54) BETTING TICKET INFORMATION PROVISION DEVICE, BETTING TICKET INFORMATION PROVISION METHOD, AND PROGRAM FOR BETTING TICKET INFORMATION PROVISION DEVICE

(71) Applicant: RAKUTEN, INC., Tokyo (JP)

(72) Inventor: Sadaaki EMURA, Tokyo (JP)

(73) Assignee: RAKUTEN, INC., Tokyo (JP)

(21) Appl. No.: 14/651,141

(22) PCT Filed: Sep. 30, 2014
(86) PCT No.: PCT/JP2014/076110

§ 371 Date: Jun. 10, 2015

(51) Int. Cl. G06Q 50/34; G07F 17/32; G06F 17/30

(52) U.S. Cl. CPC G06Q 50/34; G06F 17/3097; G07F 17/3288

(57) ABSTRACT

In betting ticket information provision devices that provide information on a betting ticket for racing (10, 30), the device: acquires information on a betting count for each buying target in each betting type of the betting ticket for a race before the race of the racing starts (S2); specifies a betting type in which a reception amount predicted to be received by a host of the racing is less than or equal to a predetermined reference value when a buying target that the betting count is maximum wins (S3, S4); and outputs recommendation information to recommend a betting type different from the specified betting type before the race of the racing starts (S8).

### TECHNICAL FIELD

The present invention relates to the technical fields of betting ticket information provision devices, betting ticket information provision methods, and programs for the betting ticket information provision devices that provide information on betting tickets for racing.

### BACKGROUND ART

In racing such as horse racing and bicycle racing, in principle, even when finished in any order of arrival, odds are calculated so that a ratio of a total payout amount to a total sales amount of betting tickets becomes almost constant to sell the betting tickets. A method for calculating the odds is called as Pari-mutuel betting. Moreover, the ratio of the total payout amount to the total sales amount of the betting tickets is called as a return rate, and a ratio of the remaining is called as a deduction rate. In a race of the racing, for each betting type of the race, respective ranges of the return rate and the deduction rate are determined in advance. Patent Document 1 discloses a system in which the payout amount is calculated according to the Pari-mutuel betting.

### CITATION LIST

### Patent Document

Patent Document 1: JP 2008-525900

### SUMMARY OF THE INVENTION

### Problem to be Solved by the Invention

In a race of racing, however, when popularity is too much concentrated on a particular racer, a deduction rate of a host side may not be secured, depending on a betting type.

The present invention has been made in view of this problem, and has an object of providing a betting ticket information provision device and others that secure the deduction rate of the host side as much as possible, as an example of the problem.

### Means for Solving the Problem

In order to solve the above problem, the invention described in claim 1 is characterized in that abetting ticket information provision device that provides information on a betting ticket for racing includes: a betting count information acquisition means that acquires information on a betting count for each buying target in each betting type of the betting ticket for a race, before the race of the racing starts; a betting type specification means that specifies a betting type in which a reception amount predicted to be received by a host of the racing is less than or equal to a predetermined reference value in the reception when a buying target that the betting count is maximum wins, for each betting type of the race; and a recommendation information output means that outputs recommendation information to recommend a betting type different from the specified betting type, before the race of the racing starts.

Thus, by recommending a user to purchase the betting ticket a betting type in which a reception amount predicted to be received by a host side is greater than a reference value, the reception amount can be greater than the reference value as much as possible, that is, a deduction rate of the host side can be secured as much as possible. Moreover, by recommending a user to purchase the betting ticket a betting type in which a reception amount predicted to be received by a host side is greater than a reference value, further concentration on a particular betting type can be prevented.

In the betting ticket information provision device described in claim 1, the invention described in claim 2 is characterized in that the device further includes a concentration calculation means that calculates a betting concentration of dividing a total betting count for a related buying target, including at least the buying target that the betting count is maximum, related to case that the buying target that the betting count is maximum wins by a betting count for a betting type of the related buying target, for each betting type of the race, and the betting type specification means specifies a betting type in which a reception amount is less than or equal to the reference value, based on the concentration.

In this case, by the concentration, a concentration degree of each betting type is accurately grasped, and the reception amount can be greater than the reference value as much as possible, that is, a deduction rate of the host side can accurately be secured as much as possible.

In the betting ticket information provision device described in claim 1 or 2, the invention described in claim 3 is characterized in that the recommendation information is point information on a point to be given to a user to purchase the betting ticket.

In this case, by the point to be given to the user to purchase the betting ticket, the user can be induced to purchase a betting type in which a reception amount predicted to be received by a host side is greater than the reference value, and the reception amount can be greater than a reference value as much as possible.

In the betting ticket information provision device described in claim 3, the invention described in claim 4 is characterized in that the recommendation information output means outputs the point information in which the point is changed for each of the betting types, based on a history of the race of the racing, in a betting type different from the specified betting type.

In this case, by giving the point according to a state of a betting type of a past race, the user can be effectively induced to purchase a betting type in which a reception amount predicted to be received by a host side is greater than a reference value, and the reception amount can be greater than the reference value as much as possible.

In the betting ticket information provision device described in claim 3 or 4, the invention described in claim 5 is characterized in that the recommendation information output means outputs the point information in which the point is changed for each of the betting types, based on a betting concentration of dividing a total betting count for a related buying target, including at least the buying target that the betting count is maximum, related to case that the buying target that the betting count is maximum wins by a betting count for a betting type of the related buying target, in a betting type different from the specified betting type.

In this case, since the point is set according to the concentration, for example, to be able to dissolve the concentration, the user can be effectively induced to purchase a betting type in which a reception amount predicted to be received by a host side is greater than a reference value, and the reception amount can be greater than the reference value as much as possible.

In the betting ticket information provision device described in any one of claims 1 to 5, the invention described in claim 6 is characterized in that the reference value is set based on information on a betting count for the other race in the racing.

In this case, an entire race of the racing can be controlled so that purchase of the betting ticket is not concentrated on a particular betting type.

The invention described in claim 7 is characterized in that a betting ticket information provision method for a betting ticket information provision device that provides information on a betting ticket for racing includes: a betting count information acquisition step of acquiring information on a betting count for each buying target in each betting type of the betting ticket for a race, before the race of the racing starts; a betting type specification step of specifying a betting type in which a reception amount predicted to be received by a host of the racing is less than or equal to a predetermined reference value when a buying target that the betting count is maximum wins, for each betting type of the race; and a recommendation information output step of outputting recommendation information to recommend a betting type different from the specified betting type, before the race of the racing starts.

The invention described in claim 8 is characterized in that a program for a betting ticket information provision device that provides information on a betting ticket for racing causes a computer to function as: a betting count information acquisition means that acquires information on a betting count for each buying target in each betting type of the betting ticket for a race, before the race of the racing starts; a betting type specification means that specifies a betting type in which a reception amount predicted to be received by a host of the racing is less than or equal to a predetermined reference value when a buying target that the betting count is maximum wins, for each betting type of the race; and a recommendation information output means that outputs recommendation information to recommend a betting type different from the specified betting type, before the race of the racing starts.

### Effect of the Invention

According to the present invention, by recommending a betting type in which a reception amount predicted to be received by a host side is greater than a reference value, the reception amount can be greater than the reference value as much as possible, that is, a deduction rate of the host side can be secured as much as possible.

### BRIEF DESCRIPTION OF THE DRAWINGS

FIG. 1 is a schematic diagram illustrating a general configuration example of a betting ticket information provision system according to an embodiment of the present invention.

FIG. 2 is a block diagram illustrating an example of a general configuration of abetting ticket information provision server in FIG. 1.

FIG. 3 is a schematic diagram illustrating an example of a betting count database of a betting ticket information provision server in FIG. 2.

FIG. 4 is a schematic diagram illustrating an example of a return rate for each betting type.

FIG. 5 is a block diagram illustrating an example of a general configuration of a host server in FIG. 1.

FIG. 6 is a block diagram illustrating an example of a general configuration of a terminal device in FIG. 1.

FIG. 7 is a flowchart illustrating an operation example of the betting ticket information provision system in FIG. 1.

FIG. 8 is a schematic diagram illustrating an example of a betting count for each buying target in a betting type.

FIG. 9 is a schematic diagram illustrating an example of a betting count for each buying target in a betting type.

FIG. 10 is a schematic diagram illustrating an example of a betting count for each buying target in a betting type.

FIG. 11 is a schematic diagram illustrating an example of a betting count for each buying target in a betting type.

FIG. 12 is a schematic diagram illustrating an example of a betting count for each buying target in a betting type.

FIG. 13 is a schematic diagram illustrating an example of a betting count for each buying target in a betting type.

FIG. 14 is a schematic diagram illustrating an example of information to be notified to a user.

FIG. 15 is a schematic diagram illustrating a relationship between a return amount and a deduction amount.

FIG. 16 is a schematic diagram illustrating a relationship between a return amount and a deduction amount for each betting type.

FIG. 17 is a schematic diagram illustrating a relationship between a return amount and a deduction amount for each betting type.

### MODES FOR CARRYING OUT THE INVENTION

Hereinafter, an embodiment of the present invention will be described with reference to the drawings. The embodiment described below is an embodiment when the present invention is applied to a betting ticket information provision system.

### [1. Outline of Configuration and Function of Betting Ticket Information Provision System]

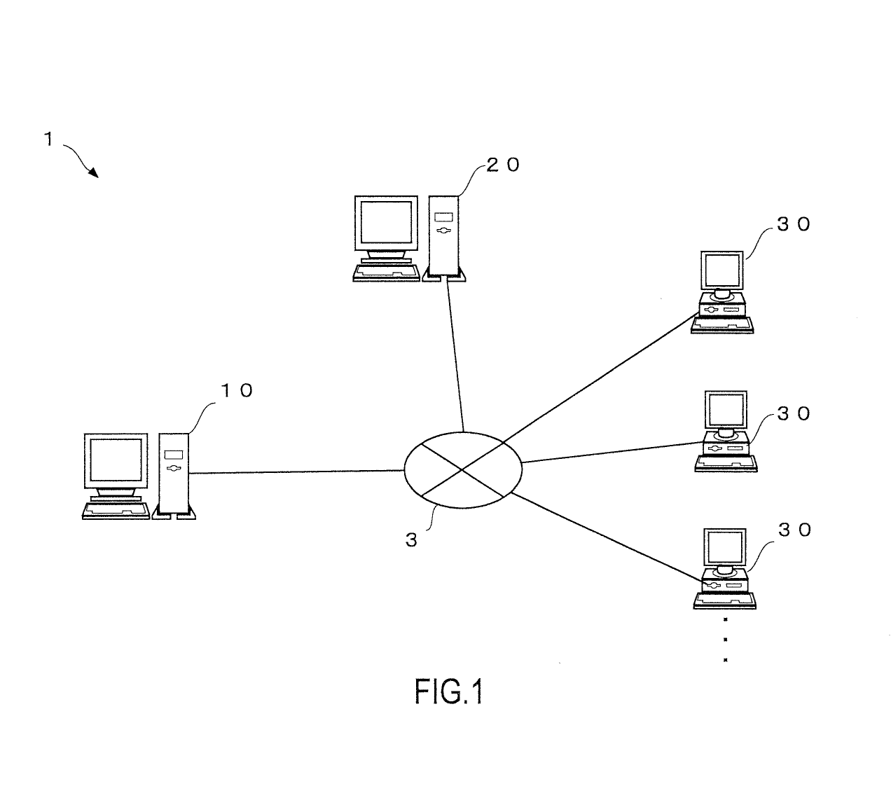

First, the configuration and general function of a betting ticket information provision system according to an embodiment of the present invention will be described with reference to FIG. 1.

FIG. 1 is a schematic diagram illustrating a general configuration example of a betting ticket information provision system 1 according to this embodiment.

As shown in FIG. 1, the betting ticket information provision system 1 includes a betting ticket information provision server 10 (an example of a betting ticket information provision device) that provides information on betting tickets for racing such as horse racing, bicycle racing, or speedboat racing, a host server 20 on the host side that hosts or operates the racing and issues betting tickets, and terminal devices 30 (an example of a betting ticket information provision device) for users to receive provision of information from the betting ticket information provision server 10 and purchase betting tickets on sporting events (races).

The betting ticket information provision server 10, the host server 20, and the terminal device 30 are connected to each other by a network 3, and can transmit and receive data with a communication protocol (for example, TCP/IP). The network 3 is constructed by the Internet, a private communication line (for example, community antenna television (CATV) line), a mobile communication network (including base stations and others), a gateway, and others, for example. Incidentally, the betting ticket information provision server 10 and the host server 20 may be connected to each other by a private line to improve security.

The betting ticket information provision server 10 receives from the host server information announced by the host such as the odds of a race, the condition of a racecourse, information on racers such as horses, bicycles, or boats to participate in a race, and the result of a race. The betting ticket information provision server 10 outputs to the terminal devices 30 information to assist purchase of betting tickets by users at the terminal devices 30. The betting ticket information provision server 10 performs processing such as reception of purchase of betting tickets, and payout for a winning betting ticket to each terminal device 30. Thus, the betting ticket information provision server 10 is a server for operating a racing site such as a horse racing site.

Here, odds refer to a dividend rate (a rate on stakes), and include those successively announced as approximate odds before the start of a race, and those announced as fixed odds (final odds fixed finally) after the close of betting ticket sale. There are odds for each betting ticket type (type of betting method, a so-called betting type) of the betting tickets, and for each buying target (buying target composed of a racer number of a racer) that designates one or more racers out of racers to participate in a race. That is, there are odds for each betting ticket corresponding to a buying target and a betting type. Incidentally, racers in a race may include horse jockeys, or participants who control or steer bicycles or boats.

Examples of betting types of betting tickets include win in which a racer predicted to finish first is designated, exacta in which racers predicted to finish first and second are designated in the correct order, trifecta in which racers predicted to finish first, second, and third are designated in the correct order, place in which a single racer predicted to finish first to third or first to second is designated, quinella in which two racers predicted to finish first to second are designated, bracket quinella in which brackets including racers predicted to finish first to second are designated, quinella place wide in which two racers predicted to finish first to third are designated, a trio in which three racers predicted to finish first to third are designated, and others.

A buying target includes, for a win, the number of a racer predicted to finish first, for an exacta, the numbers of racers predicted to finish first and second, for a trifecta, the numbers of racers predicted to finish first, second, and third, for a quinella, a combination of two designated racer numbers, for a bracket quinella, a combination of two designated bracket numbers (corresponding to the racer numbers of racers included in the brackets), for a quinella place wide, a combination of two designated racer numbers, for a trio, a combination of three designated racer numbers, and for a consecutive win, a single designated racer number.

The host server 20 performs processing of issuing betting tickets and processing of calculating odds based on issued betting tickets and announcing them to the betting ticket information provision server 10, terminal devices placed in a racecourse and a betting ticket office, and others.

There are multiple user terminal devices 30, which display information for purchasing betting tickets, and transmit information on betting tickets to be purchased to the betting ticket information provision server 10. Moreover, the user terminal devices 30 notify information on a betting ticket by an image and sound.

### [2. Configuration and Function of Each Server]

### (2.1 Configuration and Function of Betting Ticket Information Provision Server 10)

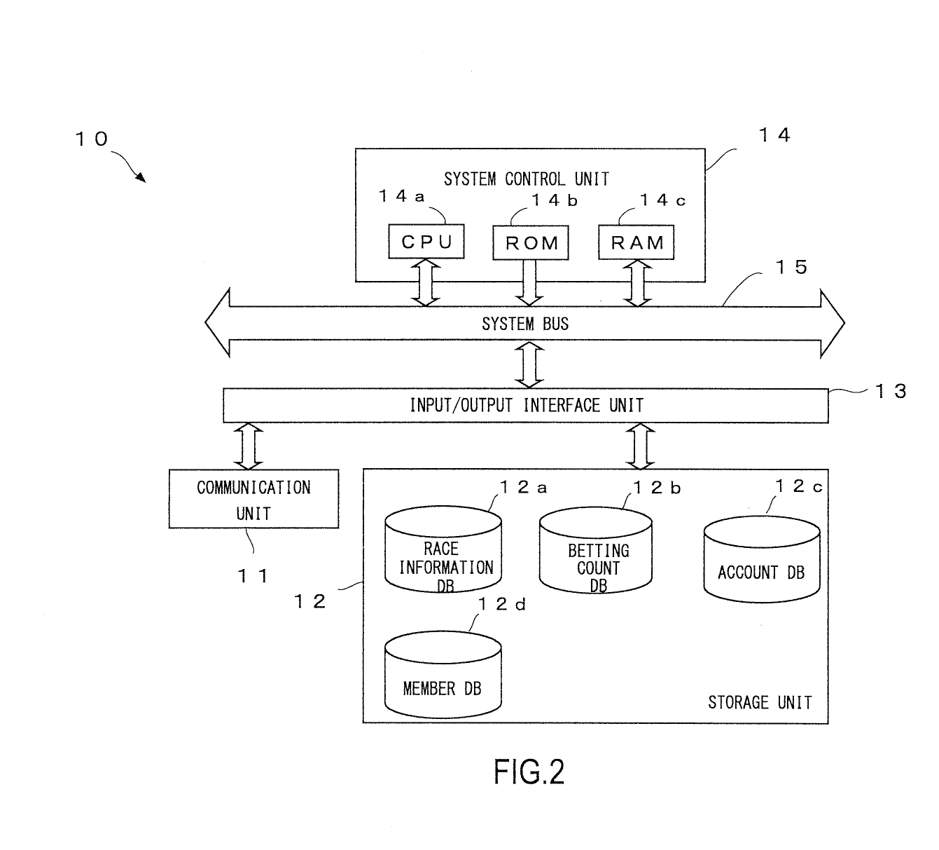

Next, the configuration and function of the betting ticket information provision server 10 will be described with reference to FIGS. 2 to 4.

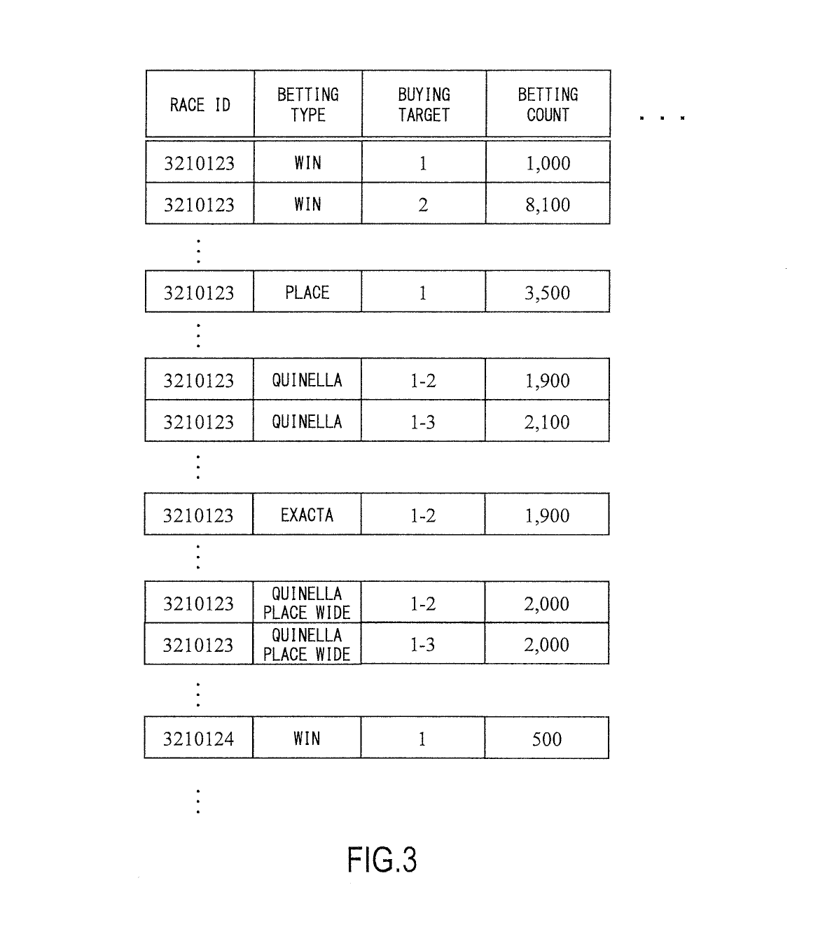

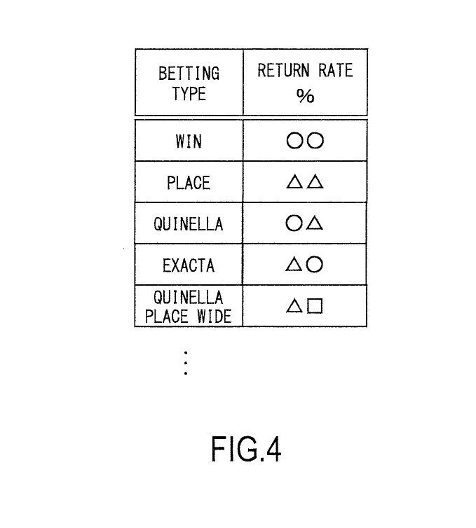

FIG. 2 is a block diagram illustrating an example of a general configuration of the betting ticket information provision server 10. FIG. 3 is a schematic diagram illustrating an example of the betting count database of a betting ticket information provision server 10. FIG. 4 is a schematic diagram illustrating an example of a return rate for each betting type.

As shown in FIG. 2, the betting ticket information provision server 10 functioning as a computer includes a communication unit 11, a storage unit 12, an input/output interface unit 13, and a system control unit 14. The system control unit 14 and the input/output interface unit 13 are connected to each other via a system bus 15.

The communication unit 11 (an example of a recommendation information output means, an example of a betting count information acquisition means) connects to the network 3 and controls the state of communication with the host server 20, the terminal devices 30, and others, and further connects to a local area network and performs transmission and reception of data to and from other servers on the local area network.

The storage unit 12 is formed by a hard disk drive or the like, for example, and stores various programs such as an operating system and a server program, screen data on webpages for presenting information on races to be provided to users, and others. Incidentally, the various programs may be acquired from other server devices or the like via the network 3, or may be recorded on recording media and read via a drive device (not shown), for example.

In the storage unit 12, a race information database 12a for storing race information and others related to a race to be held in each stadium received from the host server 20 (hereinafter referred to as “race information DB 12a”), the betting count database 12b for storing a betting count for a betting type and buying target for each race aggregated in the host server 20 (hereinafter referred to as “betting count DB 12b”), an account database 12c for storing deposit information on funds for purchasing betting tickets received from users via the terminal devices 30 (hereinafter referred to as “account DB 12c”), a member database 12d for storing information on members (hereinafter referred to as “member DB 12d”), and others are constructed.

In the race information DB 12a (an example of a storage means), race information acquired from the host server 20 such as odds information and race results is stored in association with a race ID that specifies a race to be held in each stadium.

Here, examples of race information include, in addition to approximate odds information before the start of a race, racecourse names, weathers at racecourses, race conditions such as the types of racecourses, such as whether racecourses are dirt or grass, the names of races to be held, the names, ages, and weights of horses to participate in races, the state of racers such as the types of bicycles or boats (including the names, ages, weights, and others of horse jockeys or bicycle or boat players), and others. Further, the race information includes information on final odds at the end of sale of betting tickets, the order in a race when the race is finished and the order is fixed, a time difference between the first and the second, and others.

Further, in the race information DB 12a, odds information on each betting type and on each racer pattern is stored in association with race IDs.

In the betting count DB 12b, as shown in FIG. 3, the betting count is stored for each betting type and buying target in association with the race IDs acquired from the host server 20. Incidentally, data to be described in a field of the buying target is “1-2” when a betting type is exacta, and a racer number of a racer predicted to finish first is “1” and a racer number of a racer predicted to finish second is “2.” Moreover, when a betting type is quinella, a combination of racer numbers of racers predicted to finish first and second (combination of the racer number “1” and racer number “2” of the racers) also is “1-2.”

In the account DB 12c, funds for users to purchase betting tickets are deposited, and the amounts are stored in association with user IDs. For example, a user determines a budget for betting tickets to purchase on a day when races are held, and transfers the amount of money by the budget from a bank on the Internet or the like to the account DB 12c by the terminal device 30 before buying a betting ticket. When a betting ticket wins, a payout is credited to the account DB 12c. When the user purchases a betting ticket, the amount of purchase is deducted from the balance of the user in the account DB 12c. Further, in the account DB 12c, an accumulated deposit amount as the accumulation of a deposit by a user from a bank or the like and a credit due to a payout is stored.

In the member DB 12d, user information on users registered as members (users of a horse racing site) is registered, such as user IDs, names, addresses, telephone numbers, e-mail addresses, occupations, hobbies, purchase histories, and subjects and categories of interest of the users. In the member DB 12d, user IDs, login IDs, and passwords required for users to log in to the horse racing site from the terminal devices 30 are registered. Here, the login IDs and passwords are login information used for login processing (user authentication processing).

The storage unit 12, as shown in FIG. 4, stores for each betting type a return rate to be a reference (an example of a reference value that determines in advance a reception amount predicted to be received by a host of the racing), that is, a ratio of a total amount to be paid back to a purchaser of betting tickets to a total sales of the betting tickets. Incidentally, the return rate has each range for each betting type, and is finally determined by the race result. The return rate to be the reference is set to any value within the range of the return rate.

In the storage unit 12, files or the like of webpages written in a markup language or the like such as Hypertext Markup Language (HTML) or Extensible Markup Language (XML) to allow information from the horse racing site to be displayed on the terminal devices 30 are stored.

The input/output interface unit 13 performs interface processing between the communication unit 11 and the storage unit 12, and the system control unit 14.

The system control unit 14 is constituted by a central processing unit (CPU) 14a, read-only memory (ROM) 14b, and random-access memory (RAM) 14c, or the like. The system control unit 14 performs processing for providing betting ticket information and others by the CPU 14a reading and executing various programs stored in the ROM 14b and the storage unit 12.

### (2.2 Configuration and Function of Host Server 20)

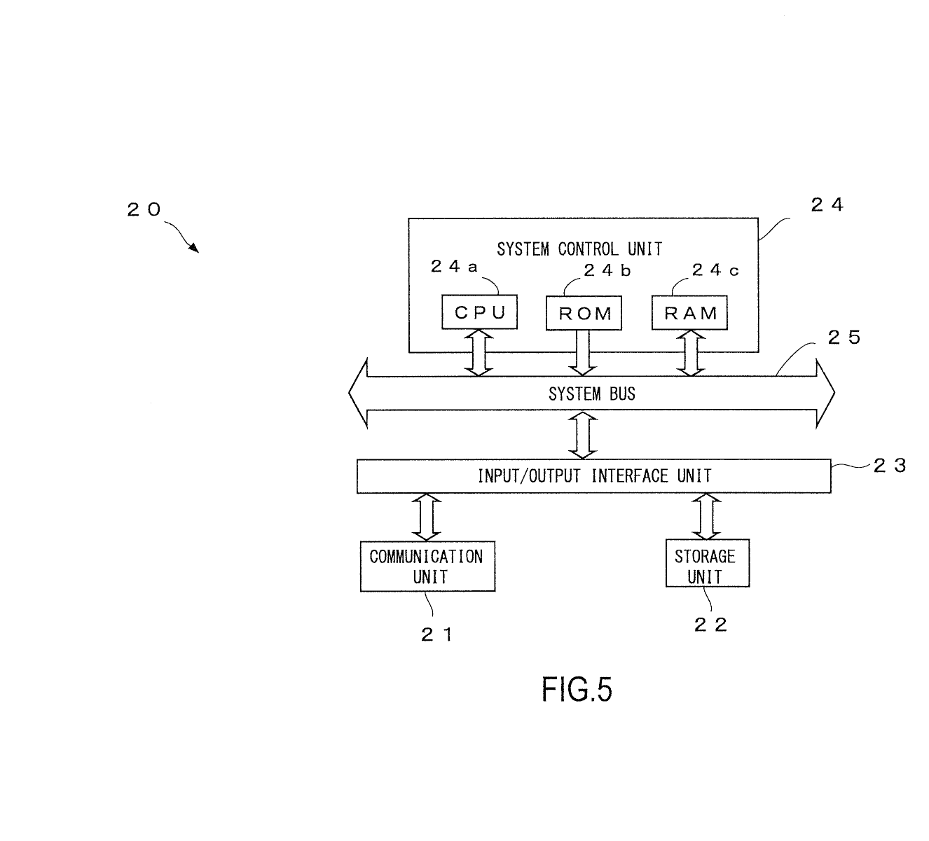

Next, the configuration and function of the host server 20 will be described with reference to FIG. 5.

FIG. 5 is a block diagram illustrating an example of a general configuration of the host server 20.

As shown in FIG. 5, the host server 20 includes a communication unit 21, a storage unit 22, an input/output interface unit 23, and a system control unit 24, and the system control unit 24 and the input/output interface unit 23 are connected via a system bus 25. The configuration and function of the host server 20 are almost identical to the configuration and function of the betting ticket information provision server 10, and thus difference in each component and each function of the betting ticket information provision server 10 will be mainly described.

The communication unit 21 performs control of the state of communication with the terminal devices 30 and the betting ticket information provision server 10 through the network 3, the local area network, or the like, and others.

In the storage unit 22, information on races and the like are stored.

The system control unit 24 is constituted by a CPU 24a, ROM 24b, and RAM 24c, or the like. The system control unit 24 performs processing of transmitting odds information to the betting ticket information provision server 10 and others by the CPU 24a reading and executing various programs stored in the ROM 24b and the storage unit 22.

### (2.3 Configuration and Function of Terminal Device 30)

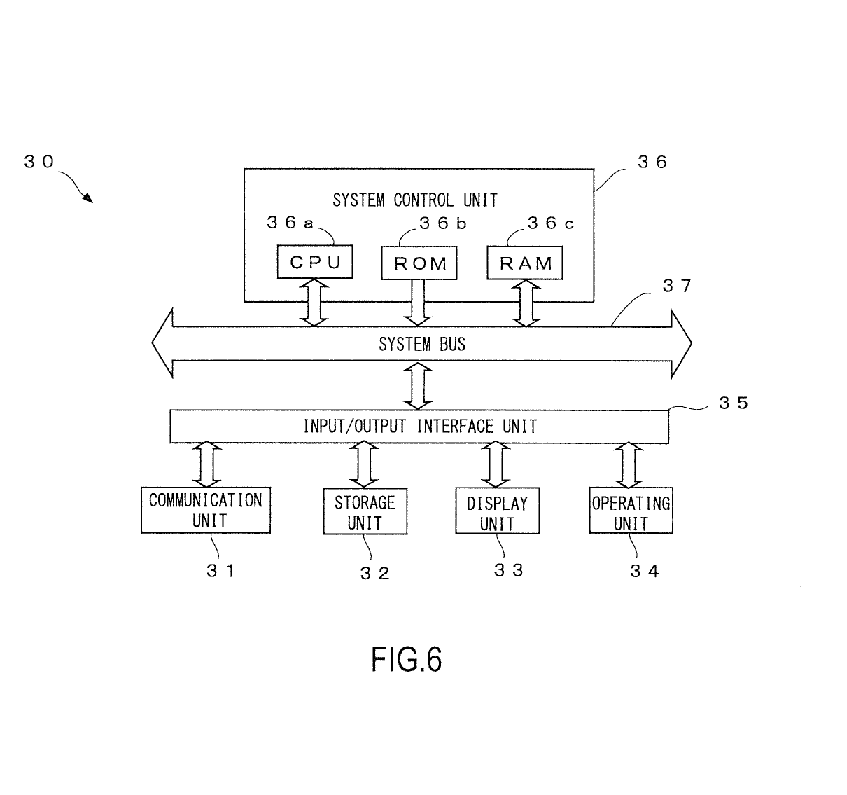

Next, the configuration and function of the terminal devices 30 will be described with reference to FIG. 6.

FIG. 6 is a block diagram illustrating an example of a general configuration of the terminal devices 30.

As shown in FIG. 6, a terminal device 30 functioning as a computer may be a personal computer, a portable wireless telephone such as a smartphone, or a mobile terminal such as a PDA, for example, and includes a communication unit 31, a storage unit 32, a display unit 33, an operating unit 34, an input/output interface unit 35, and a system control unit 36. The system control unit 36 and the input/output interface unit 35 are connected to each other via a system bus 37.

The communication unit 31 (an example of the betting count information acquisition means) controls communication with the betting ticket information provision server 10 and others through the network 3. When the terminal device 30 is a mobile terminal device, the communication unit 31 has a wireless communication function for connection to a mobile communication network in the network 3.

The storage unit 32 has, for example, a hard disk drive or the like, and stores an operating system, a web browser program, a web browser tool bar program, and others. Moreover, the storage unit 32 stores dedicated software (so-called application) that displays information from the betting ticket information provision server 10 or purchases betting tickets, and others.

The display unit 33 (an example of the recommendation information output means) is constituted by a liquid crystal display device, an electro luminescence (EL) device, or the like, for example. On the display unit 33, a top page screen of a horse racing site or a webpage of a race information table for the purchase of a betting ticket on a specific race is displayed by a web browser.

The operating unit 34 is constituted by a keyboard and a mouse, or the like, for example. A user enters a response with the operating unit 34. When the display unit 33 is a touch switch type display panel such as a touch panel, the operating unit 34 acquires information on a location on the display unit 33 that the user contacts or comes close to.

The input/output interface unit 35 is an interface between the communication unit 31 and the storage unit 32, and the system control unit 36.

The system control unit 36 has a CPU 36a, ROM 36b, and RAM 36c, for example. In the system control unit 36, the CPU 36a reads and executes various programs stored in the ROM 36b, the RAM 36c, and the storage unit 32. For example, the system control unit 36 executes a web browser program, functioning as a web browser.

### [3. Operation of Betting Ticket Information Provision System]

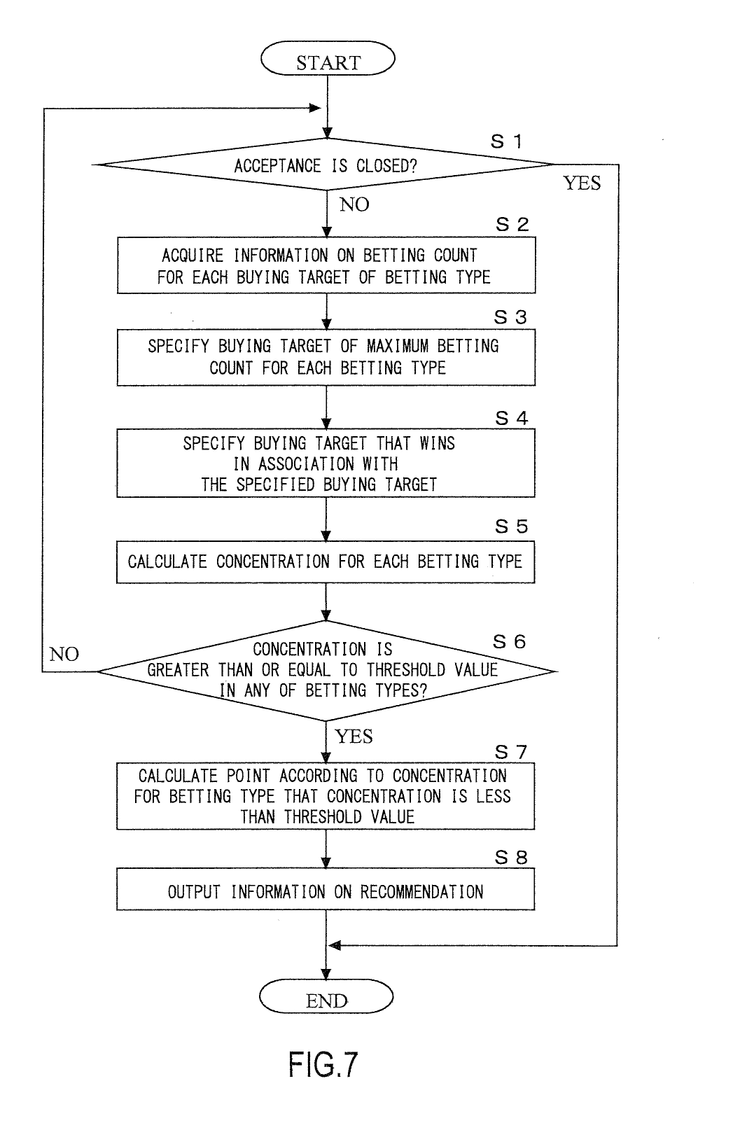

Next, an operation of the betting ticket information provision system 1 according to an embodiment of the present invention will be described with reference to FIGS. 7 to 14.

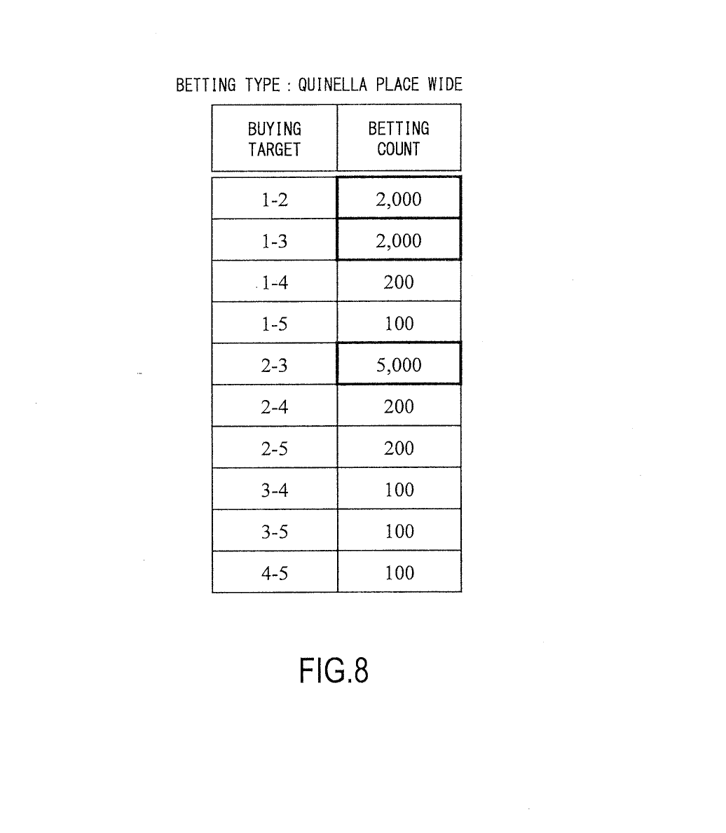

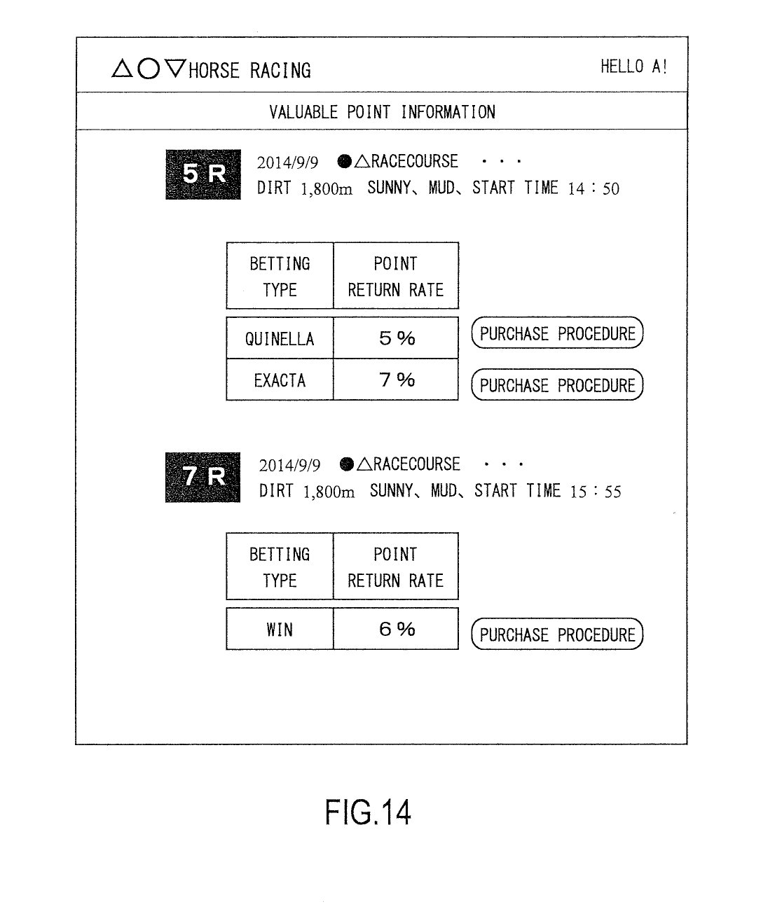

FIG. 7 is a flowchart illustrating an operation example of the betting ticket information provision system 1. FIGS. 8 to 13 are schematic diagrams illustrating examples of the betting count for each buying target in the betting type. FIG. 14 is a schematic diagram illustrating an example of information to be notified to a user.

As shown in FIG. 7, the betting ticket information provision system 1 determines whether or not acceptance of betting tickets for a race of a betting ticket is closed (step S1). Specifically, the betting ticket information provision server 10 determines whether or not the acceptance is closed in regard to the race of the race number of the betting ticket. For example, the acceptance of the betting tickets is closed at a predetermined time before the time when a predetermined race is started, or when information on the close of acceptance of the betting tickets is received from the host server 20. The predetermined time, for example, is set in consideration of the time required for a user to purchase the betting tickets.

When the acceptance of the betting tickets is closed (step S1; YES), the betting ticket information provision system 1 terminates processing.

When the acceptance of the betting tickets is not closed (step S1; NO), the betting ticket information provision system 1 acquires information on the betting count for each buying target of the betting type (step S2). Specifically, the betting ticket information provision server 10 acquires the information on the betting count for each buying target of the betting type as race information from the host server 20. Incidentally, the betting ticket information provision server 10 may acquire the race information stored in the betting count DB 12b by receiving from the host server 20.

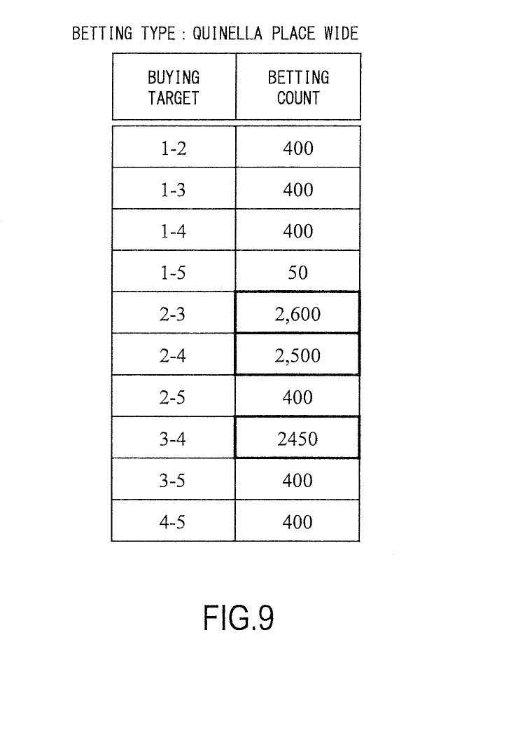

As shown in FIGS. 8 and 9, the betting ticket information provision server 10, when the number of racers is five and the betting type is “quinella place wide,” acquires information on the betting count for all buying targets “1-2,” “1-3,” “1-4,” “1-5,” “2-3,” “2-4,” “2-5,” “3-4,” “3-5,” “4-5,” for each race.

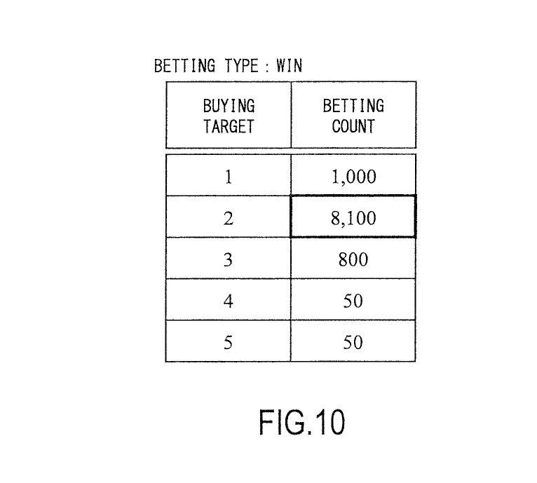

As shown in FIG. 10, the betting ticket information provision server 10, when the number of racers is five and the betting type is “win,” acquires information on the betting count for all buying targets “1,” “2,” “3,” “4,” “5,” for each race.

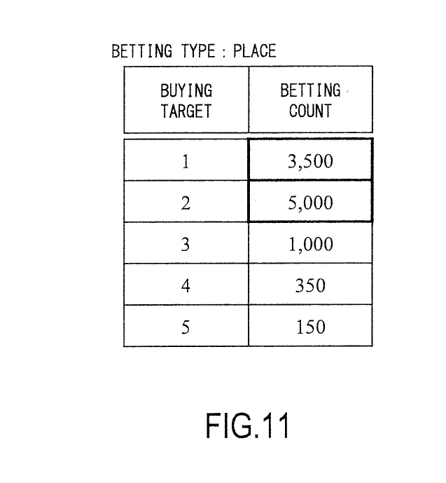

As shown in FIG. 11, the betting ticket information provision server 10, when the number of racers is five and the betting type is “place,” acquires information on the betting count for all buying targets “1,” “2,” “3,” “4,” “5,” for each race.

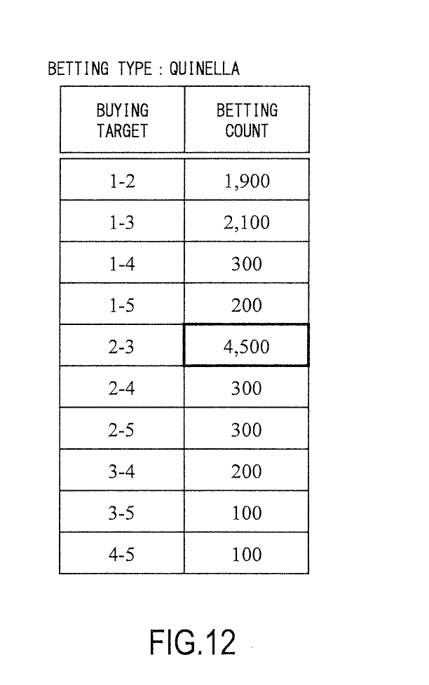

As shown in FIG. 12, the betting ticket information provision server 10, when the number of racers is five and the betting type is “quinella,” acquires information on the betting count for all buying targets “1-2,” “1-3,” “1-4,” “1-5,” “2-3,” “2-4,” “2-5,” “3-4,” “3-5,” “4-5,” for each race.

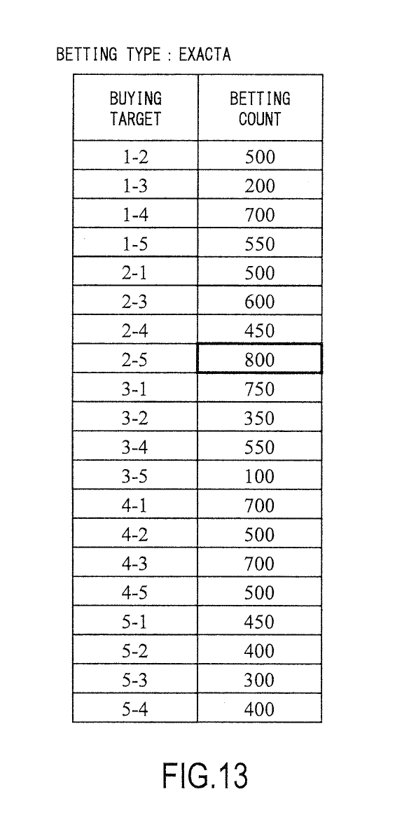

As shown in FIG. 13, the betting ticket information provision server 10, when the number of racers is five and the betting type is “exacta” acquires all buying targets “1-2,” “1-3,” “1-4,” “1-5,” “2-1,” “2-3,” “2-4,” “2-5,” “3-1,” “3-2,” “3-4,” “3-5,” “4-1,” “4-2,” “4-3,” “4-5,” “5-1,” “5-2,” “5-3,” “5-4,” for each race.

Thus, the betting ticket information provision server 10 functions as an example of the betting count information acquisition means that acquires information on the betting count for each buying target in each betting type of the betting ticket for the race, before the race of the racing starts.

Here, generation of race information will be described.

The betting ticket information provision server 10, at predetermined time intervals, aggregates betting ticket purchase information received from each terminal device 30 including the other users for each race, betting type, and buying target to generate summary data. The betting ticket information provision server 10 transmits generated summary data to the host server 20.

Incidentally, the betting ticket information provision server 10 may transmit the summary data to the host server 20 at irregular intervals, instead of the predetermined time intervals, or may transmit the summary data to the host server 20 in response to a request from the host server 20. Moreover, the summary data are data, for example, that normally do not include user IDs corresponding to names of respective users and in which the betting count is aggregated for each race, betting type, and buying target.

The host server 20, based on the summary data from the betting ticket information provision server 10, data from betting ticket counter, and others, aggregates the betting count for each betting type and buying target in each race to calculate odds. Moreover, the host server 20 acquires information on the condition of the racecourse. The host server 20 generates the race information from calculated odds, acquired information on the condition of the racecourse, and others.

Incidentally, the system control unit 24 of the host server 20 may transmit the race information to the betting ticket information provision server 10 at irregular intervals, instead of the predetermined time intervals, or may transmit the race information to the betting ticket information provision server 10 in response to a request from the betting ticket information provision server 10. Moreover, the system control unit 24 of the host server 20 may transmit odds information to the betting ticket information provision server 10 each time the odds are updated.

Then, the betting ticket information provision system 1 specifies a buying target of the maximum betting count for each betting type (step S3). Specifically, the betting ticket information provision server 10 specifies the buying target of the maximum betting count for each betting type.

For example, in the cases shown in FIGS. 8 and 9, the betting ticket information provision server 10 specifies the buying target of the maximum betting count “2-3.” In the cases shown in FIGS. 10 and 11, the betting ticket information provision server 10 specifies the buying target of the maximum betting count “2.” In the case shown in FIG. 12, the betting ticket information provision server 10 specifies the buying target of the maximum betting count “2-3.” In the case shown in FIG. 13, the betting ticket information provision server 10 specifies the buying target of the maximum betting count “2-5.”

Then, the betting ticket information provision system 1 specifies a buying target that wins in association with the buying target specified as the maximum betting count (step S4). Specifically, the betting ticket information provision server 10 specifies the buying target that wins in association with the buying target specified as the maximum betting count.

For example, in the case of the betting type “quinella place wide,” since two racers predicted to finish first to third are designated, when the buying target of the maximum betting count is “2-3,” the racer of the racer number “2” and the racer of the racer number “3” are the buying target that wins in association with the order of arrival pattern predicted to finish first to third. That is, the buying target “1-2” and “1-3” in which the racer of the racer number “1” also finishes first to third, the buying target “2-4” and “3-4” in which the racer of the racer number “4” also finishes first to third, and the buying target “2-5” and “3-5” in which the racer of the racer number “5” also finishes first to third, are the buying target that wins in association with the buying target specified as the maximum betting count.

Further, the betting ticket information provision server 10 may specify the buying target in which a total betting count for the buying target that wins in association with is high, among these.

Incidentally, when there is only one buying target to win, as in the cases of the betting type “win,” the betting type “quinella,” the betting type “exacta,” and others, since there is no buying target that wins in association with, the betting ticket information provision server 10 may omit the processing of step S4.

Then, the betting ticket information provision system 1 calculates a concentration of each betting type (step S5). Specifically, the betting ticket information provision server 10, in a certain race, calculates the concentration of each betting type of dividing the betting count obtained by adding the betting count for the buying target specified as the maximum betting count and the betting count for the buying target that wins in association with by a total betting count for the betting type (a total of betting count for all buying targets).

Here, the concentration is a degree indicating how much betting count is concentrated on the buying target specified as the maximum betting count and the buying target that wins in association with. When the buying target wins, the concentration is the return rate to be paid back to the purchaser of the betting ticket from the host.

Moreover, there is only one buying target to win, as in the cases of the betting type “win,” the betting type “quinella,” the betting type “exacta,” and others, since there is no buying target that wins in association with, the betting count for the buying target that wins in association with is zero, and each concentration of these betting types is a value of dividing the betting count for the buying target specified as the maximum betting count by the total betting count.

For example, in the case shown in FIG. 8, the betting ticket information provision server 10 divides the total “9,000” of the betting count “5,000” for the buying target “2-3” specified as the maximum betting count, the betting count “2,000” for the buying target “1-2” that wins in association with, and the betting count “2,000” for the buying target “1-3” that wins in association with by the total betting count “10,000” to calculate the concentration 90%.

In the case shown in FIG. 9, the betting ticket information provision server 10 divides the total “7,550” of the betting count “2,600” for the buying target “2-3” specified as the maximum betting count, the betting count “2,500” for the buying target “2-4” that wins in association with, and the betting count “2,450” for the buying target “3-4” that wins in association with by the total betting count “10,000” to calculate the concentration 75.5%.

In the case shown in FIG. 10, the betting ticket information provision server 10 divides the betting count “8,100” for the buying target “2” specified as the maximum betting count by the total betting count “10,000” to calculate the concentration 81%.

In the case shown in FIG. 11, the betting ticket information provision server 10 divides the total “8,500” of the betting count “5,000” for the buying target “2” specified as the maximum betting count and the betting count “3,500” for the buying target “1” that wins in association with by the total betting count “10,000” to calculate the concentration 85%.

In the case shown in FIG. 12, the betting ticket information provision server 10 divides the betting count “4,500” for the buying target “2-3” specified as the maximum betting count by the total betting count “10,000” to calculate the concentration 45%.

In the case shown in FIG. 13, the betting ticket information provision server 10 divides the betting count “800” for the buying target “2-5” specified as the maximum betting count by the total betting count “10,000” to calculate the concentration 8%.

Incidentally, when there are multiple combinations of buying targets that win in association with, as in the cases of the betting type “quinella place wide, and” the betting type “place,” the betting ticket information provision server 10 may calculate each combination concentration and adopt a combination with the buying target that wins in association with and to be the maximum concentration.

Then, the betting ticket information provision system 1 determines whether or not the concentration is greater than or equal to a threshold value in any of the betting types (step S6). Specifically, the betting ticket information provision server 10 refers to a database of the storage unit 12 to determine whether or not the concentration is greater than or equal to a return rate to be a reference of each betting type (an example of a predetermined reference value).

For example, when the return rate to be the reference of the betting type “quinella place wide” is 75%, the concentration is 90% in the case as shown in FIG. 8 and the concentration is 75.5% in the case as shown in FIG. 9, and both exceed the return rate to be the reference. Incidentally, FIG. 9 is an example of the concentration close to the return rate.

When the return rate to be the reference of the betting type “win” is 75%, the concentration is 81% in the case as shown in FIG. 10, and it exceeds the return rate to be the reference.

When the return rate to be the reference of the betting type “place” is 70%, the concentration is 85.5% in the case as shown in FIG. 11, and it exceeds the return rate to be the reference.

When the return rate to be the reference of the betting type “quinella” is 75%, the concentration is 45% in the case as shown in FIG. 12, and it does not exceed the return rate to be the reference.

When the return rate to be the reference of the betting type “exacta” is 75%, the concentration is 8% in the case as shown in FIG. 13, and it does not exceed the return rate to be the reference.

Thus, the betting ticket information provision server 10 functions as an example of the betting type specification means that specifies a betting type in which a reception amount predicted to be received by a host of the racing is less than or equal to a predetermined reference value when a buying target that the betting count is maximum wins, for each betting type of the race. The betting ticket information provision server 10 functions as an example of the concentration calculation means that calculates a betting concentration of dividing a total betting count for a related buying target, including at least the buying target that the betting count is maximum, related to case that the buying target that the betting count is maximum wins by a betting count for a betting type of the related buying target, for each betting type of the race. The betting ticket information provision server 10 functions as an example of the betting type specification means that specifies a betting type in which the reception amount is less than or equal to the predetermined value, based on the concentration.

Incidentally, the predetermined reference value may be lower than the return rate to be the reference, and may be outside the range of the return rate. By setting the reference value lower, it is prevented in advance to be less than the deduction rate. The reference value may be set based on information on the betting count for the other race in the racing. When they are much less than the reference values in all betting types in many of the other races, if the deduction rate of the host side as a whole can be secured, the reference value may be increased.

When the concentration is less than the threshold value in any of the betting types (step S6; YES), the betting ticket information provision system 1 returns to the processing of step S1.

When the concentration is greater than or equal to the threshold value in any of the betting types (step S6; YES), the betting ticket information provision system 1 calculates a point according to the concentration for the betting type that the concentration is less than the threshold value (step S7). Specifically, the betting ticket information provision server 10 calculates a point that is given to the user and is increased as the concentration is lower in the betting type that the concentration is less than the threshold value in the same race. Incidentally, the relationship between the concentration and the point is determined based on a predetermined relational expression, a predetermined table, or the like.

Then, the betting ticket information provision system 1 outputs the recommendation information (step S8). Specifically, the betting ticket information provision server 10 generates the recommendation information displaying point information on a point given to a betting type that the concentration is less than a threshold value for each race as shown in FIG. 14. The betting ticket information provision server 10 transmits generated recommendation information to each terminal device 30. Incidentally, the betting ticket information provision server 10 may transmit the recommendation information as email notification to an email address that is associated in the member DB 12d.

As shown in FIG. 14, each terminal device 30 displays received recommendation information on the display unit 33. When the user purchases the betting ticket of the betting type of the race recommended, the point is given to the user. When transmitted as the email to the email address that is associated in the member DB 12d, the recommend information is displayed on the display unit 33 as a screen of the email.

Thus, the betting ticket information provision server 10 functions as an example of the recommendation information output means that outputs recommendation information to recommend a betting type different from the specified betting type, before the race of the racing starts.

The betting ticket information provision system 1 outputs the recommendation information to terminate a series of processing steps. Incidentally, after the processing of step S8, it may return to the processing of step S1. In this case, the betting ticket information provision system 1 may calculate a concentration at step S5 and calculate a point according to the latest concentration, based on the latest odds information until the acceptance of the betting ticket is closed.

As described above, according to this embodiment, by recommending a user to purchase the betting ticket a betting type in which the reception amount predicted to be received by a host side is greater than a reference value, the reception amount can be greater than the reference value as much as possible, that is, a deduction rate of the host side can be secured as much as possible. Moreover, by recommending a user to purchase the betting ticket a betting type in which a reception amount predicted to be received by a host side is greater than a reference value, further concentration on a particular betting type can be prevented.

In addition, since further concentration on the particular betting type can be prevented, even in the cases odds for payout is set to be increased to 1.1 and the like by the host side only in a particular betting type when the odds become 1.0 in the so-called principal return, or there is an amount to be paid by the host side to give a point, loss of the host side can be reduced as much as possible.

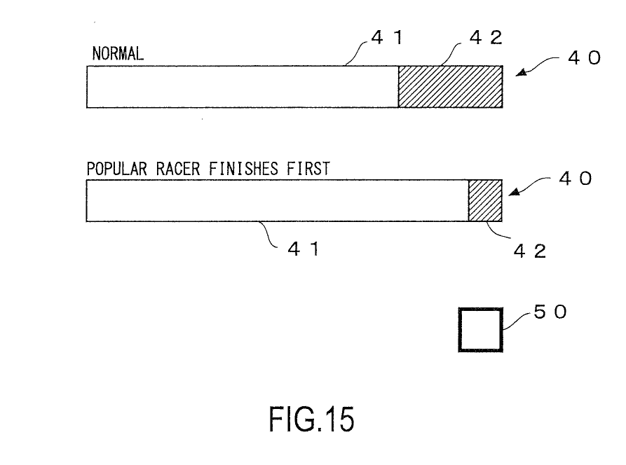

As shown in FIG. 15, in the normal case that popularity is not so much concentrated on a particular racer, the return rate that is a ratio of a return amount 41 to a sales amount 40 is not very high, and the deduction rate that is a ratio of a deduction amount 42 to the sales amount 40 is not very low. Therefore, the deduction amount 42 that remains in the host side becomes more than an operating cost 50.

On the other hand, when an extremely popular racer finishes first, the return rate that is the ratio of the return amount 41 to the sales amount 40 becomes high, and the deduction rate that is the ratio of the deduction amount 42 to the sales amount 40 becomes low. A case may occur where the deduction amount 42 that remains in the host side becomes smaller than the operating cost 50, and there is a possibility that becomes a deficit of the host side.

Here, to simplify the description, the betting types are only two kinds, “exacta” and “quinella place wide.”

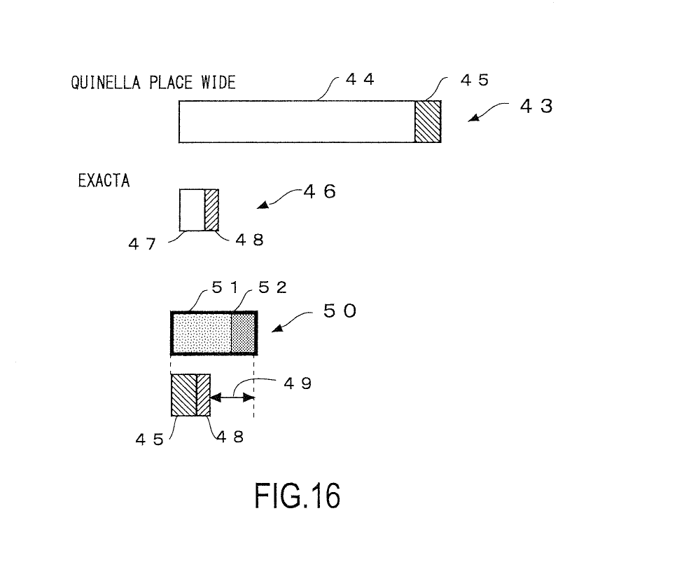

As shown in FIG. 16, when popularity is concentrated on a particular buying target of the betting type “quinella place wide,” a sales amount 43 of the betting type “quinella place wide.” is increased. When the acceptance of the betting ticket is closed as it is and the buying target on which the popularity is concentrated wins, a return amount 44 of the betting type “quinella place wide” is increased, a deduction amount 45 of the betting type “quinella place wide” is decreased, and the return rate of the betting type “quinella place wide” becomes high. That is, the concentration of the betting type “quinella place wide” becomes greater than or equal to the threshold value.

On the other hand, a sales amount 46 of the betting type “exacta” that the concentration is less than the threshold value (composed of a return amount 47 of the betting type “exacta” and a deduction amount 48 of the betting type “exacta”) becomes less than the sales amount 43 of the betting type “quinella place wide.”

As shown in FIG. 16, although the host side obtains a sum of the deduction amount 45 of the betting type “quinella place wide” and the deduction amount 48 of the betting type “exacta,” the sum may be smaller than the operating cost 50, and a deficit amount 49 may occur. Incidentally, the operating cost 50 is composed of a holding cost 51 to hold the race (fixed amount) and a point cost 52 that is proportional to a total betting ticket sales amount (for example, point funds, tax).

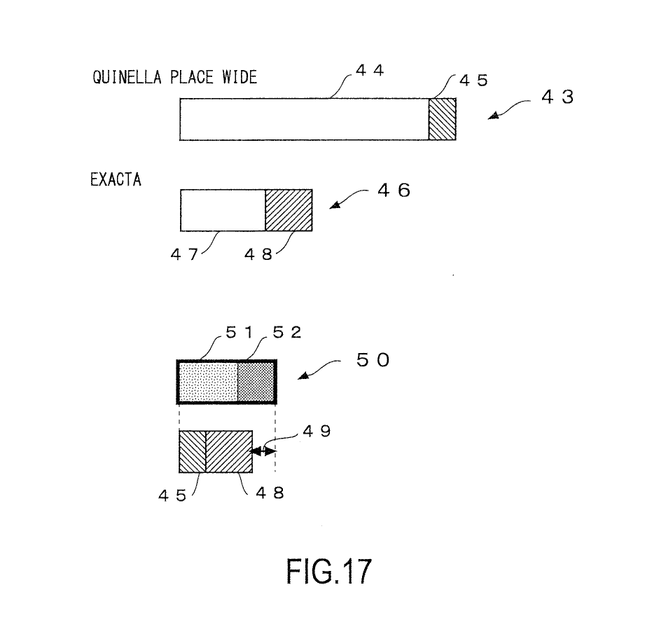

However, as in step S8, when the betting ticket information provision server 10 displays the recommendation information that displays the point to be given for the betting type “exacta” that the concentration is less than the threshold value on the display unit 33 of the terminal device 30 and the user purchases the betting ticket of the betting type “exacta” of the race recommended, as shown in FIG. 17, since the user tries to earn the point, the possibility of increasing the sales amount 46 of the betting type “exacta” becomes high.

As shown in FIG. 17, the sales amount 46 of the betting type “exacta” increases, and the deduction amount 48 of the betting type “exacta” also increases. As shown in FIG. 17, even when the point cost 52 increases, since the deduction amount 48 of the betting type “exacta” increases more, at least the deficit amount 49 decreases compared to that before inducing to the betting type on which popularity is not be concentrated.

When calculating a betting concentration of dividing a total betting count for a related buying target, including at least a buying target that the betting count is maximum, related to case that the buying target that the betting count is maximum wins by a betting count for a betting type of the related buying target, for each betting type of the race and, based on the concentration, specifying the betting type in which a reception amount is less than or equal to a reference value, by the concentration, a concentration degree of each betting type is accurately grasped, and the reception amount can be greater than the reference value as much as possible, that is, a deduction rate of the host side can accurately be secured as much as possible.

When the recommendation information is point information on a point to be given to a user to purchase the betting ticket, by the point, the user can be induced to purchase a betting type in which the reception amount predicted to be received by the host side is greater than the reference value, and the reception amount can be greater than the reference value as much as possible.

When the point is changed for each of the betting types, based on a history of a race of the racing, in a betting type different from specified betting type, by giving a point according to a state of the betting type of a past race, the user can be effectively induced to purchase a betting type in which the reception amount predicted to be received by the host side is greater than the reference value, and the reception amount can be greater than the reference value as much as possible.

When the point is changed for each of the betting type, based on a betting concentration of dividing a total betting count for a related buying target, including at least the buying target that the betting count is maximum, related to case that the buying target that the betting count is maximum wins by a betting count for a betting type of the related buying target, for each betting type of the race, in a betting type different from the specified betting type, since the point is set according to the concentration, for example, to be able to dissolve the concentration, the user can be effectively induced to purchase a betting type in which the reception amount predicted to be received by the host side is greater than the reference value, and the reception amount can be greater than the reference value as much as possible.

When the reference value is set based on information on the betting count for the other race of the racing, in an entire race of the racing, it is possible to perform accurate control so that purchase of the betting tickets is not concentrated on a particular betting type.

Incidentally, the processing from step S1 to S8 may be performed by the terminal device 30 with application software.

At step S1, the terminal device 30 acquires from the betting ticket information provision server 10 information on whether or not the acceptance of the betting ticket is closed to perform determination.

At step S2, the terminal device 30 acquires from the betting ticket information provision server 10 information on the betting count for each buying target of the betting type.

At step S3, the terminal device 30 specifies the buying target of the maximum betting count for each betting type.

As in step S4, the terminal device 30 specifies a buying target that wins in association with the buying target specified as the maximum betting count.

As in step S5, the terminal device 30 calculates a concentration for each betting type.

As in step S6, the terminal device 30 determines whether or not the concentration is greater than or equal to the threshold value in any of the betting type.

As in step S7, the terminal device 30 calculates a point according to a concentration for a betting type that the concentration is less than the threshold value.

As in step S8, the terminal device 30 generates recommendation information that displays a point and displays the recommendation information on the display unit 33.

Even when the terminal device 30 performs a series of processing by the betting ticket information provision server 10, the same effect can be obtained.

Further, the present invention is not limited to the above embodiment. The above embodiment is illustrative, and anything having components substantially identical to the technical idea described in the claims of the present invention and providing similar functions and effects is included in the technical scope of the present invention.

### EXPLANATION OF REFERENCE NUMERALS

1 betting ticket information provision system
10 betting ticket information provision server (betting ticket information provision device)
12a race information DB
12b betting count DB
20 host server
30 terminal device (betting ticket information provision device)

1. A betting ticket information provision device that provides information on a betting ticket for racing, the device comprising:
a betting count information acquisition unit that acquires information on a betting count for each buying target in each betting type of the betting ticket for a race, before the race of the racing starts;
a betting type specification unit that specifies a betting type in which a reception amount predicted to be received by a host of the racing is less than or equal to a predetermined reference value when a buying target that the betting count is maximum wins, for each betting type of the race; and
a recommendation information output unit that outputs recommendation information to recommend a betting type different from the specified betting type, before the race of the racing starts.

2. The betting ticket information provision device according to claim 1, further comprising:
a concentration calculation unit that calculates a betting concentration of dividing a total betting count for a related buying target, including at least the buying target that the betting count is maximum, related to case that the buying target that the betting count is maximum wins by a betting count for a betting type of the related buying target, for each betting type of the race, wherein
the betting type specification unit specifies a betting type in which a reception amount is less than or equal to the reference value, based on the concentration.

3. The betting ticket information provision device according to claim 1, wherein
the recommendation information is point information on a point to be given to a user to purchase the betting ticket.

4. The betting ticket information provision device according to claim 3, wherein
the recommendation information output unit outputs the point information in which the point is changed for each of the betting types, based on a history of the race of the racing, in a betting type different from the specified betting type.

5. The betting ticket information provision device according to claim 3, wherein
the recommendation information output unit outputs the point information in which the point is changed for each of the betting types, based on a betting concentration of dividing a total betting count for a related buying target, including at least the buying target that the betting count is maximum, related to case that the buying target that the betting count is maximum wins by a betting count for a betting type of the related buying target, in a betting type different from the specified betting type.

6. The betting ticket information provision device according to claim 1, wherein
the reference value is set based on information on a betting count for the other race in the racing.

7. A betting ticket information provision method for a betting ticket information provision device that provides information on a betting ticket for racing, the method comprising:
a betting count information acquisition step of acquiring information on a betting count for each buying target in each betting type of the betting ticket for a race, before the race of the racing starts;
a betting type specification step of specifying a betting type in which a reception amount predicted to be received by a host of the racing is less than or equal to a predetermined reference value when a buying target that the betting count is maximum wins, for each betting type of the race; and
a recommendation information output step of outputting recommendation information to recommend a betting type different from the specified betting type, before the race of the racing starts.

8. A non-transitory computer-readable recording medium having a program for a betting ticket information provision device that provides information on a betting ticket for racing, the program causing a computer to function as:
a betting count information acquisition unit that acquires information on a betting count for each buying target in each betting type of the betting ticket for a race, before the race of the racing starts;
a betting type specification unit that specifies a betting type in which a reception amount predicted to be received by a host of the racing is less than or equal to a predetermined reference value when a buying target that the betting count is maximum wins, for each betting type of the race; and
a recommendation information output unit that outputs recommendation information to recommend a betting type different from the specified betting type, before the race of the racing starts.
